(19) United States
(12) Patent Application Publication
(10) Pub. No.: US 2004/0058220 A1
(43) Pub. Date: Mar. 25, 2004

(54) Fuel cell reactant and byproduct systems

(76) Inventors: Qin Liu, Corvallis, OR (US); Marzio Leban, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/251,244

(22) Filed: Sep. 20, 2002

(51) Int. Cl. H01M 8/02; H01M 4/86

(52) U.S. Cl. 429/38; 429/13; 429/44

(57) ABSTRACT

Fuel cell system in accordance with present inventions include reactant distribution systems and/or byproduct removal systems.

### BACKGROUND OF THE INVENTIONS

1. Field of the Inventions

The present inventions are related to fuel cells and fuel cell reactant and byproduct systems.

2. Description of the Related Art

Fuel cells, which convert fuel and oxidant into electricity and reaction product(s), are advantageous because they possess higher energy density and are not hampered by lengthy recharging cycles, as are rechargeable batteries, and are relatively small, lightweight and produce virtually no environmental emissions. Nevertheless, the inventors herein have determined that conventional fuel cells are susceptible to improvement. More specifically, the inventors herein have determined that it would be advantageous to provide improved systems for delivering reactant to fuel cell electrodes and removing byproducts from the electrodes.

On the anode side, for example, conventional fuel cell fuel delivery systems continuously pump liquid fuel to the anodes and immerse the anodes in fuel. The inventors herein have determined that this method of delivering fuel to the anodes leads to fuel crossover from the anodes to cathodes, which reduces the overall efficiency of the fuel cell. Fuel crossover also necessitates the use of lower concentration fuels, which results in a system that is bulkier and heavier than it otherwise would be. It is also difficult to achieve a uniform distribution of fuel over the anodes using convention fuel cell fuel delivery systems. With respect to the byproducts of the reaction at the anodes, the inventers herein have determined that more efficient removal of the byproducts would improve fuel cell reaction rates and increase power density.

### BRIEF DESCRIPTION OF THE DRAWINGS

Detailed description of preferred embodiments of the inventions will be made with reference to the accompanying drawings.

FIG. 1 is a diagrammatic view of a fuel cell system in accordance with a preferred embodiment of a present invention.

FIG. 1A is a plan view showing a fuel cell arrangement in accordance with a preferred embodiment of a present invention.

FIG. 2 is an exploded section view of a fuel cell that may be used in conjunction the illustrated embodiments.

FIG. 3 is a side, section view of a fuel cell stack in accordance with a preferred embodiment of a present invention.

FIG. 4 is a side, section view of a portion of a fuel cell stack in accordance with a preferred embodiment of a present invention.

FIG. 5 is a side, partial section view of a fuel cell in accordance with a preferred embodiment of a present invention.

FIG. 6 is a plan, partial section view of a portion of a fuel cell stack in accordance with a preferred embodiment of a present invention.

FIG. 7 is a section view taken along line 7-7 in FIG. 6.

FIG. 7A is a section view taken along line 7A-7A in FIG. 6.

FIG. 8 is a plan, partial section view of a portion of a fuel cell stack in accordance with a preferred embodiment of a present invention.

FIG. 9 is a section view of a byproduct removal tube in accordance with a preferred embodiment of a present invention.

FIG. 10 is a plan, partial section view of a portion of a fuel cell stack in accordance with a preferred embodiment of a present invention.

FIG. 11 is a section view taken along line 11-11 in FIG. 10.

FIG. 12 is a section view of a portion of a fuel cell stack in accordance with a preferred embodiment of a present invention.

FIG. 13 is a section view of a portion of a fuel cell stack in accordance with a preferred embodiment of a present invention.

FIG. 14 is a plan, partial section view of a portion of a fuel cell stack in accordance with a preferred embodiment of a present invention.

FIG. 15 is a section view taken along line 15-15 in FIG. 14.

FIG. 16 is a section view taken along line 16-16 in FIG. 14.

### DETAILED DESCRIPTION OF THE PREFERRED EMBODIMENTS

The following is a detailed description of the best presently known modes of carrying out the inventions. This description is not to be taken in a limiting sense, but is made merely for the purpose of illustrating the general principles of the inventions. It is noted that detailed discussions of fuel cell structures that are not pertinent to the present inventions have been omitted for the sake of simplicity.

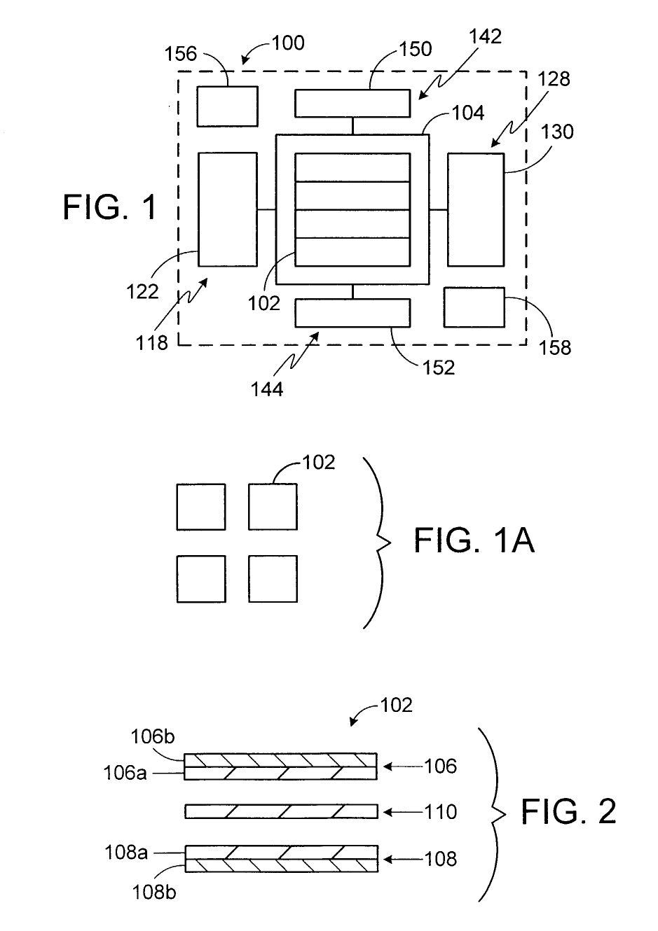

The present inventions are also applicable to a wide range of fuel cell technologies, including those presently being developed or yet to be developed. Thus, although various exemplary fuel cell systems are described below with reference to a direct methanol fuel cell (“DMFC”), other types of fuel cells where liquid reactant is involved, such as ethanol and enzymatic fuel cells, are equally applicable to the present inventions. Additionally, the fuel cells in the exemplary embodiments illustrated in the Figures are arranged in pairs that have the anodes facing one another (sometimes referred to as a “shared anode chamber” arrangement). Successive fuel cell pairs may be stacked vertically (two pairs are stacked in FIG. 1) or placed next to one another in planar fashion (four pairs are shown in FIG. 1A). A single pair may also be used by itself. Alternatively, individual fuel cells may be stacked in the traditional bipolar configuration, placed next to one another in planar fashion or simply used by themselves.

As illustrated for example in FIGS. 1-3, a fuel cell system 100 in accordance with one embodiment of the present invention includes a plurality of fuel cells 102 arranged in a stack 104. Each fuel cell 102 includes an anode 106 and a cathode 108 separated by a thin, ionically conducting membrane 110. The anode 106 and cathode 108, on opposing faces of the membrane 110, form a membrane electrode assembly (“MEA”). In the exemplary implementations, the anode 106 consists of a catalyst layer 106a and a porous current collector 106b. The exemplary cathode 108 consists of a catalyst layer 108a and a porous current collector 108b. The exemplary ionically conducting membrane 110 functions as an electrolyte. In an alternative MEA that may be used in conjunction with the present inventions, the catalyst layers 106a and 108a may be carried by the membrane 110 or, in still another alternative arrangement, the anode, cathode and membrane may each be provided with catalyst layers. Moreover, additional metal current collectors may be placed in contact with the porous current collectors, which may or may not be metal.

The individual cells 102 in the exemplary system 100 are stacked such that the anodes 106 of adjacent cells face one another, with a space of about 0.05 mm to about 5 mm therebetween, and the cathodes 108 of adjacent cells face one another, with a space of about 0.1 mm to about 10 mm therebetween. The cathodes 108 at the ends of the stack 104 face walls 114. So arranged, the spaces between adjacent anodes 106 define fuel regions 112 and the spaces between adjacent cathodes 108 (or a cathode and a wall 114) define oxidant regions 116. Anodes and cathodes can be connected in series, in parallel or in some combination of series and parallel depending on the power requirements of the load. In the shared anode chamber arrangement, two adjacent anodes 106 may be connected to one another in parallel, and their respective cathodes 108 may also be connected in parallel, and the parallel pairs of anodes are connected in series to the next parallel pairs of cathodes.

In the exemplary DMFCs 102, a liquid fuel such as a methanol/water mixture is supplied to the fuel region 112 and oxygen or air is supplied to the oxidant region 116. The fuel is electrochemically oxidized at the anodes 106, thereby producing a byproduct (carbon dioxide in the exemplary embodiment) and protons that migrate across the conducting membranes 110 and react with the oxygen at the cathodes 108 to produce a byproduct (water vapor in the exemplary embodiment).

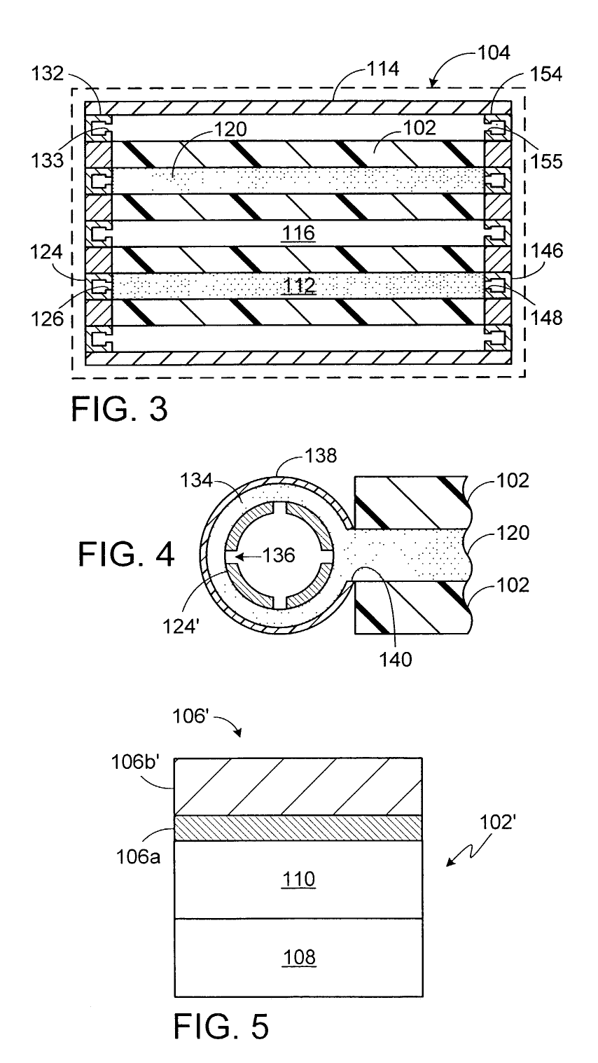

As illustrated in FIGS. 1 and 3, the fuel in the exemplary fuel cell system 100 is supplied under relatively low pressure to the inlets of the fuel regions 112 by a fuel supply apparatus 118 and is then distributed in a thin layer over the surfaces of the anodes 106 by a fuel distribution element 120. The fuel supply apparatus 118 preferably includes an active device 122, such as a pump that draws fuel from a reservoir or a pressurized reservoir (such as a bladder) and valve arrangement that functions like a pump, and a manifold or other distribution arrangement that includes fuel supply channels 124. The fuel supply channels 124 supply fuel to the fuel distribution element 120. Although the present inventions are not limited to any particular method of transferring fuel from the fuel supply channels 124 to the fuel distribution element 120, the exemplary fuel supply channels illustrated in FIG. 3 include longitudinally extending slots 126 that abut the associated fuel distribution elements. Alternatively, a portion of one of the edges of the fuel distribution elements 120 may be inserted into the associated slots 126. The length of the slots 126 will substantially correspond to the length of the fuel distribution elements 120. Sealing material may be provided if required.

Oxidant may be supplied to the oxidant regions 116 by an oxidant supply apparatus 128. Preferably, the oxidant supply apparatus 128 will simply be a suitable vent 130 (with a fan, if necessary) that allows atmospheric air to flow into the oxidant regions 116 and to the surfaces of the cathodes 108 by way of a manifold or other distribution arrangement that includes oxidant supply channels 132 with slots 133.

An exemplary alternative connection between a fuel distribution element and a fuel supply channel is illustrated in FIG. 4. Here, an exemplary fuel supply channel 124′ is surrounded by a fuel distribution element 134 that may be formed from material with the same properties as the fuel distribution element 120. The fuel distribution element 134 receives fuel by way of apertures 136 that are formed in the fuel supply channel. In the exemplary implementation, where the exemplary fuel supply channel 124′ is a tubular structure, the apertures 136 are formed in the sidewall of the tubular structure. The apertures 136 are preferably located within a longitudinally extending region, such as the region that is coextensive with the associated edge the fuel distribution element 120, and are preferably located at various points around the periphery of the region. Alternatively, a porous tube (such as a porous metal tube) or a non-metal porous filter may be used in place of the fuel supply channel 124′. A cap 138, with an opening 140 for the fuel distribution element 120, surrounds the fuel distribution element 134. The fuel distribution elements 120 and 134 may be integral (as shown) or two separate elements that are in communication with one another.

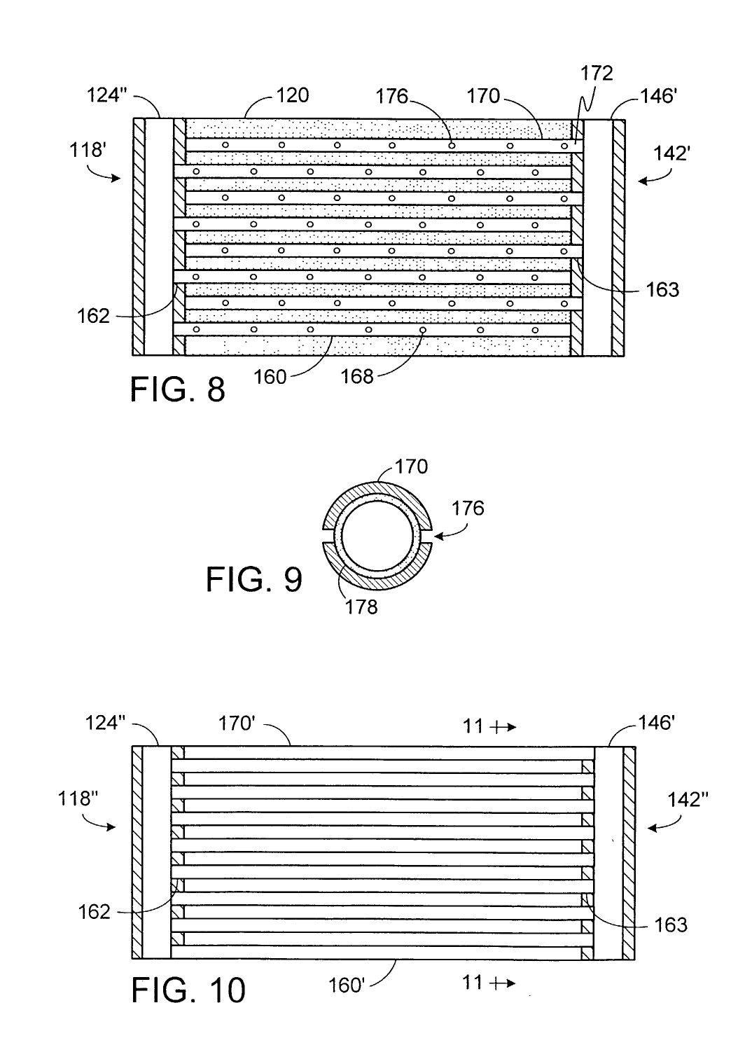

The exemplary fuel cell system 100 illustrated in FIGS. 1-3 also includes an anode-side byproduct removal apparatus 142 and a cathode-side byproduct removal apparatus 144. As noted above, the byproduct on the anode sides of the exemplary DMFCs will be carbon dioxide, while the byproduct on the cathode sides will be water vapor and unused air. The anode-side byproduct removal apparatus 142 preferably includes a manifold or other distribution arrangement that has byproduct outlet channels 146 in communication with the outlet edges of the fuel regions 112. Longitudinally extending slots 148, which abut the edges of the fuel distribution elements 120, may be formed in the byproduct outlet channels 146. Alternatively, a portion of the edges of the fuel distribution elements 120 may be inserted into the slots 148. A liquid gas separation membrane can be incorporated into the slots 148 or vent openings and the gaseous byproduct may be released through this membrane. In addition to the vent openings, a low pressure relief valve or, as described in greater detail below with reference to FIG. 8, an active device 150 that creates a vacuum force (such as a pump) may be used to eject the byproduct from the byproduct outlet channels 146. The cathode-side byproduct removal apparatus 144 may simply be a suitable vent 152 (with a fan, if necessary) that vents the byproduct from the oxidant regions 116 to the atmosphere by way of a manifold or other distribution arrangement that includes byproduct outlet channels 154 with slots 155. Alternatively, the oxidant regions 116 may be sufficiently wide to allow natural air convection to replenish the air and remove the byproducts, especially in the case of a planar fuel cell arrangement.

It should be noted here that although the cross-sectional shapes of the exemplary fuel supply channels 124, oxidant supply channels 132, byproduct outlet channels 146 and byproduct outlet channels 154 is square, the shapes may be varied as desired to suit particular situations. Other suitable cross-sectional shapes include, but are not limited to, geometric shapes such are circles and rectangles.

The exemplary fuel distribution elements 120 preferably create capillary (or “wicking”) forces and draw the fuel from one end of the fuel distribution element to the other end (and from side to side) and distribute the fuel over the surface of the anode 106. In other words, the fuel distribution elements 120 use capillary forces to draw fuel from the fuel region inlets and passively distribute the fuel over the surface of the anode 106. Structures that create capillary forces should be distinguished from structures that are merely porous and do not create any significant capillary forces on the liquid fuel that is being consumed. Capillary force is a function of the size of the capillary structure and the contact angle (which is itself a function of the interaction between the liquid fuel and the surface of the capillary material). Merely porous structures require a pump (or other active element) to force the liquid fuel through the porous material, while the fuel supply apparatus 118 in the illustrated embodiment need only deliver to the edge of the fuel distribution elements 120.

A wide variety of capillary structures may be used to form, either in whole or in part, the fuel distribution elements 120. By way of example, but not limitation, a variety of electrically non-conductive materials such as films embossed with micro-channels (on both sides in the exemplary shared anode chamber embodiment), porous hollow fibers, porous membranes, foams, filament bundles and woven or non-woven fabrics may be employed. Electrically conductive materials, such as metal foams, carbon or graphite foams, metal filters, carbon filters, metallized foams, metallized membranes, metallized films embossed with micro-channels, and porous hollow metal tubes, may also be employed in the exemplary fuel distribution elements 120. [Films embossed with micro-channels are described in greater detail below with reference to FIG. 13.] Alternatively, a combination of non-conductive capillary materials (such as porous hollow fibers) and conductive metal fibers/filaments may be employed. The electrically conductive material may act as a current collector that is incorporated into the fuel distribution structure. Alternatively, the current collector will simply be incorporated into the associated electrode, as is discussed below with reference to FIG. 5.

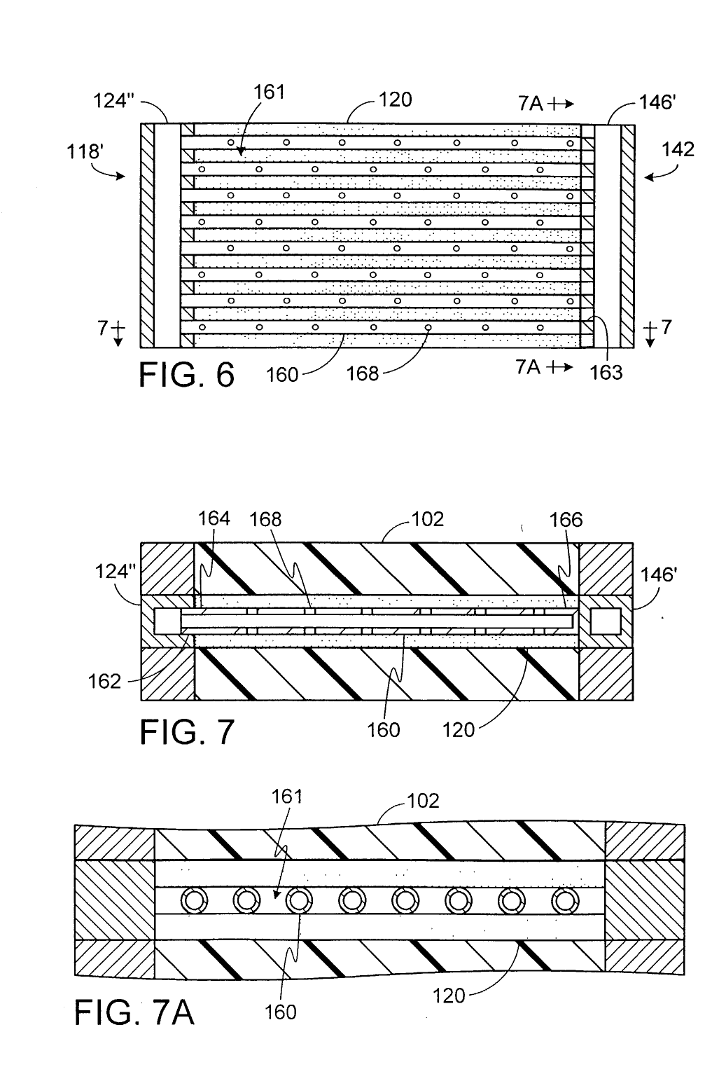

The exemplary anodes and fuel distribution elements described above are separate structural elements that may be combined with one another during assembly of the fuel cell system. Fuel distribution elements may, alternatively, be incorporated in the fuel cell anodes themselves. As illustrated for example in FIG. 5, a fuel cell 102′, which is otherwise identical to the fuel cell 102, may be provided with an anode 106′ that has a catalyst layer 106a and a current collector 106b′ that is both electrically conductive and configured to create capillary forces. More specifically, in addition to collecting current, the current collector 106b′ creates capillary forces that passively distribute the fuel over the catalyst layer 106a. Such a current collector 106b′ may be formed from one or more of the electrically conductive fuel distribution materials described in the preceding paragraph. The fuel distributing current collector 106b′ in the exemplary fuel cell 102′ may be configured such that the longitudinal ends of the current collector extend into the slots 126 and 148 in the channels 124 and 146. Alternatively, the exemplary fuel cell 102′ may be used in the fuel cell systems that include fuel distribution tubes, such as those described below with reference to FIGS. 6-11, as well as other systems.

A controller 156 (see FIG. 1) may be used to control the operation of the fuel cell system 100 including, for example, controlling the output of the fuel supply apparatus 118 so that the fuel is supplied at a rate that is proportional to current draw. At steady state, the fuel will be consumed at the same rate that the fuel is being supplied to the fuel distribution elements 120, thereby reducing fuel crossover. The fuel may, alternatively, be metered in time-based units. Here, the controller 156 would, for example, control the fuel supply apparatus 118 to supply enough fuel for the system to run for a predefined time interval (e.g. 1 minute) and, at the end of the interval, cause the next interval's worth of fuel to be supplied if current is still being drawn. The controller 156 and fuel supply apparatus 118 may also be used to shut off the fuel cells 102 by simply shutting off the active device 122 (i.e. by turning off the pump or closing the valve associated with the bladder). The relatively small amount of fuel that remains at the anodes 106 when the system is shut down may be used to charge an on-board energy storage device 158 such as a battery or capacitor. The controller 156 may, alternatively, be eliminated and the control functions provided by the host device that is being powered by the exemplary fuel cell system 100. In either case, it should be noted that the configuration of the fuel supply apparatus 118 may vary to suit particular situations. For example, the manifold may be configured such that all of the fuel supply channels 124 in the stack 104 are connected directly to a single active device 122. Alternatively, each fuel supply channel 124 may be connected to its own active device 122, or subsets of the fuel supply channels may be connected to respective active devices.

There are a variety of advantages associated with the present fuel cell systems. For example, the fuel distribution elements deliver fuel to the anode in a thin uniform layer, which facilitates precise control of the fuel delivery process, reduces fuel crossover and increases efficiency as compared to conventional systems. Reduced fuel crossover also facilitates the use of higher concentration fuel, thereby lowering the overall weight of the system. The present fuel cell systems are also orientation independent because the fuel pump (or other active element) and fuel distribution elements deliver fuel to the fuel regions and distribute the fuel over the surfaces of the anodes regardless of the orientation of the system. The present fuel cell systems also provide improved fuel distribution at the anode, and facilitate improved control of the fuel delivery process, thereby further improving fuel utilization. Moreover, in addition to supplying fuel, the fuel pump (or other active element) may be used to stop the flow of fuel, or even reverse it, when there is no load on the fuel cell, thereby improving overall efficiency.

In addition to the capillary forces provided by the fuel distribution elements 120, fuel distribution in a fuel cell system (such as the system 100 illustrated in FIG. 1) may be augmented by the fuel supply apparatus 118′ illustrated in FIGS. 6-7A. The fuel supply apparatus 118′ is substantially similar to the fuel supply apparatus 118. Here, however, fuel is transferred from the fuel supply channels 124″ to various regions between the side edges of (i.e. within the perimeter of) the fuel distribution elements 120, as opposed to being supplied to the edges of the fuel distribution elements in the manner illustrated in FIG. 3. Such an arrangement improves response rate because the fuel is distributed more quickly and evenly and is especially useful in fuel cells with anodes having relatively large surface areas. In the exemplary implementation illustrated in FIGS. 6-7A, the fuel is transferred from the fuel supply channels 124″ to various points within the fuel distribution elements 120 through a plurality of spaced fuel distribution tubes 160. The fuel supply channels 124″ include a plurality of apertures 162 for the inlet ends 164 of the fuel distribution tubes 160. The downstream ends 166 of the fuel distribution tubes 160 may be open or closed.

The exemplary fuel distribution tubes 160 are formed from liquid impervious material that includes apertures 168 through which the fuel flows into the fuel distribution elements 120. Alternatively, the fuel distribution tubes 160 may be formed from porous material, with or without additional apertures, or a combination of porous and non-porous materials. The distribution tubes 160 may also be in the form of porous hollow fibers that create their own capillary forces and are liquid permeable along their length which allow the fuel to escape. Such porous hollow fibers will preferably be hydrophilic in the exemplary fuel cells described herein.

With respect to the relative positioning of the fuel distribution tubes 160 and fuel distribution elements 120 in the exemplary embodiment, each fuel region 112 includes a pair of fuel distribution elements and the plurality of fuel distribution tubes 160 are located therebetween. The fuel distribution tube apertures 168 abut the fuel distribution elements 120. The spaces between the fuel distribution tubes 160, which are generally represented by reference numeral 161, allow gaseous byproduct to flow to apertures 163 in the byproduct outlet channels 146′. Alternatively, depending on the manner in which adjacent fuel cells 102 are arranged, the fuel distribution tubes 160 may be located on top of, below, or embedded within a single fuel distribution element 120 that is located within each fuel region 112.

The cross-sectional shape of the fuel distribution tubes 160, which preferably extend from the fuel supply channels 124″ to positions at or near the byproduct outlet channels 146′, may be varied as desired to suit particular situations. Suitable cross-sectional shapes include, but are not limited to, geometric shapes such are circles, squares and rectangles. The number and spacing of the fuel distribution tubes 160 may also be varied as desired. In the exemplary embodiment tube to open area ration is preferably ≦1.

Fuel cell systems in accordance with the present inventions may be provided with byproduct removal apparatus that facilitate the removal of anode-side byproducts without removing unused fuel or interfering with the capillary action of fuel distribution elements 120. As illustrated for example in FIGS. 8 and 9, a fuel cell system (such as the system 100 illustrated in FIG. 1) may be provided with an exemplary byproduct removal apparatus 142′ that includes a plurality of byproduct removal tubes 170. In the illustrated embodiment, the byproduct removal apparatus 142′ is in a system that also includes a fuel supply apparatus 118′, with fuel distribution tubes 160, and the byproduct removal tubes 170 are interspersed between the fuel distribution tubes 160. It should be noted, however, the byproduct removal apparatus 142′ may also be used in fuel cell systems that include a fuel supply apparatus, such as the fuel supply apparatus 118 illustrated in FIG. 3, that does not include fuel distribution tubes. Byproduct from the anode-side reaction enters the exemplary byproduct removal tubes 170 along their length. The outlet ends 172 of the byproduct removal tubes 170 are connected to apertures 163 in the byproduct outlet channels 146′. Removing byproduct in this manner drives the reaction towards the products, thereby improving the reaction rate of the fuel cell, and a faster reaction rate increases the power density. Additionally, the removal of gaseous byproduct from the reaction chamber increases the effective surface area and power density. In a closed system with a control element, such as a pressure release valve, the byproduct may be removed without introducing oxygen.

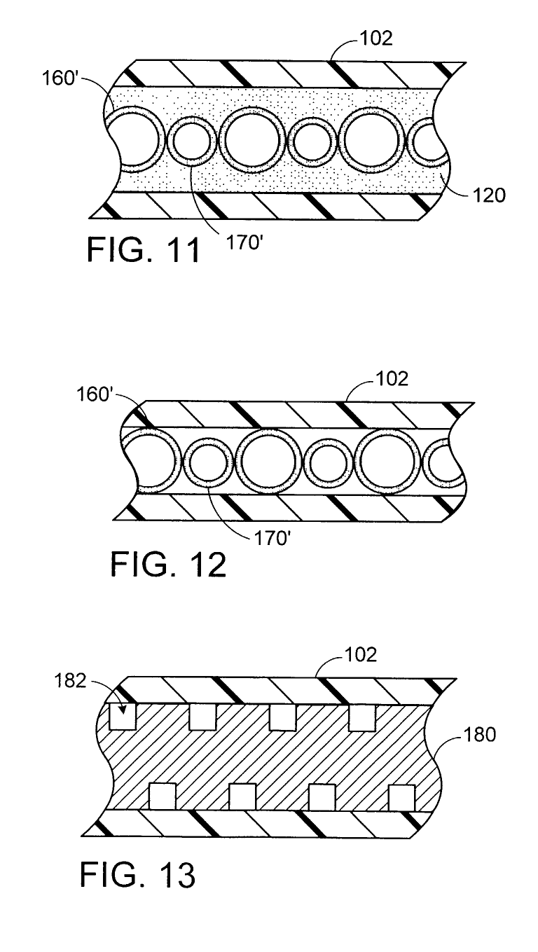

The fuel in the illustrated embodiment is a liquid (a methanol/water mixture) and the anode-side byproduct is a gas (carbon dioxide). In order to remove the byproduct without removing the fuel, the exemplary byproduct removal tubes 170 are liquid impermeable and gas permeable. For example, the byproduct removal tubes 170 may be formed from liquid impervious material that includes apertures 176 and a gas permeable, liquid impermeable lining 178. The gas permeable, liquid impermeable lining 178, which may be formed from, for example, membrane materials such as Gore-Tex® or polypropylene with pores of suitable size, may be on the interior of the byproduct removal tubes 170 (as shown) or the exterior. Other alternative byproduct removal tubes are discussed below with reference with FIGS. 10 and 11.

The cross-sectional shape of the byproduct removal tubes 170, which preferably extend from a position near the fuel supply channels 124″ to the byproduct outlet channels 146′, may be varied as desired to suit particular situations. Suitable cross-sectional shapes include, but are not limited to, geometric shapes such are circles, squares and rectangles. The number and spacing of the byproduct removal tubes 170 may also be varied as desired. In the exemplary embodiment, where they are interspersed between the fuel distribution tubes 160 in a one-to-one ratio, the fuel distribution tube to open area or byproduct removal tube ratio is preferably ≦1. In those instances where there are no fuel distribution tubes 160, the number of the byproduct removal tubes 170 could be increased. With respect to the positioning of the byproduct removal tubes 170 relative to the fuel distribution elements 120, the byproduct removal tubes may be located on top of, below, or embedded within (as shown) the fuel distribution elements.

Additionally, as noted above with reference to FIG. 1, an optional mechanism for augmenting the removal of byproduct from the anode side of the exemplary fuel cells 102 is aforementioned active device 150, such as a pump. The active device 150 may also be used in combination with the a byproduct removal apparatus, such as one of the byproduct removal apparatuses 142′ and 142″(described below), that includes a plurality of byproduct removal tubes.

Another exemplary embodiment of the present inventions is illustrated in FIGS. 10 and 11. Here, a fuel cell system (such as the system 100 illustrated in FIG. 1) is provided with a fuel supply apparatus and a byproduct removal apparatus that both include tubes which are in the form of hollow porous fibers. More specifically, in the exemplary fuel supply apparatus 118″, the fuel distribution tubes 160′ are in the form of hydrophilic porous hollow fibers that allow liquid fuel to escape into the fuel distribution elements 120 as the fuel is drawn from one end (i.e. the ends inserted into the fuel supply channel apertures 162) of the tubes to the other. With respect to byproduct removal, the byproduct removal tubes 170′ in the exemplary byproduct removal apparatus 142″ are in the form of hydrophobic porous hollow fibers that are impermeable to the liquid fuel and are permeable along their lengths to the gaseous byproduct. After entering the byproduct removal tubes 170′, the byproduct will exit the fuel cell system by way of the byproduct outlet channels 146′.

In the exemplary embodiment illustrated in FIGS. 10 and 11, the fuel distribution tubes 160′ and byproduct removal tubes 170′ are interspersed in close proximity with one another. The spacing may be increased as desired to suit particular situations. Although the byproduct removal tubes 170′ are somewhat smaller than the fuel distribution tubes 160′ in cross-sectional area (both here and in the exemplary implementation illustrated in FIG. 12), the ratio is one-to one with respect to the number of tubes. This ratio may also be varied as desired to suit particular situations. The byproduct removal tubes 170′ may, alternatively, be the same size as the fuel distribution tubes 160′ or larger than the fuel distribution tubes. With respect to positioning, the fuel distribution tubes 160′ and byproduct removal tubes 170′ may be located on top of, below, or embedded within (as shown) the fuel distribution elements.

It should also be noted that, as is illustrated for example in FIG. 12, the hydrophilic porous hollow fibers 160′ used for fuel distribution and hydrophobic porous hollow fibers 170′ used for byproduct removal may simply be placed adjacent to the surfaces of the fuel cells 102 without the fuel distribution elements 120.

Turning to FIG. 13, a plastic film 180 may be embossed with very fine channels 182 that have small equivalent radii and create capillary forces. Some of the films may need to be surface treated to facilitate proper contact angles with the liquid fuel. In a DMFC, for example, it is preferable that the surfaces form low to very low contact angles with a methanol and water mixture. The surface treatment should also be stable to the repeated transportation of liquid fuel thereover and the anode chamber environment. Plasma coatings and some metal or metal oxide deposition may be suitable for DMFC fuel or other polar fuels.

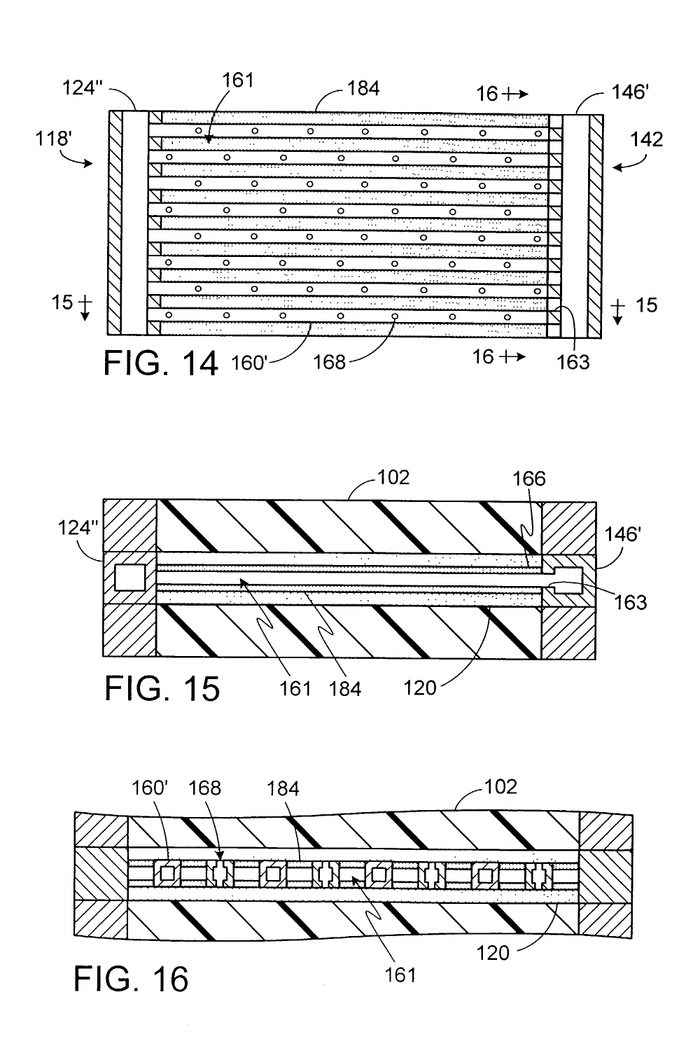

As illustrated for example in FIGS. 14-16, gas permeable, liquid impermeable strips 184 may be placed between the spaced fuel distribution tubes 160′. The gas permeable, liquid impermeable strips 184 substantially reduces the amount of liquid fuel that could find its way into the byproduct removal spaces 161 and, accordingly, reduces the amount of byproduct gas near the anodes. Suitable gas permeable, liquid impermeable materials include membrane materials such as Gore-Tex® or polypropylene with pores of suitable size.

Although the present inventions have been described in terms of the preferred embodiments above, numerous modifications and/or additions to the above-described preferred embodiments would be readily apparent to one skilled in the art. By way of example, but not limitation, the reactant and byproduct systems disclosed herein may be employed on the cathode side of a fuel cell in those instances where the cathode-side reactant is a liquid or the reaction byproduct is a liquid (such as water) and the reactant is gas (such as air or O₂). Additionally, although the inventions herein are described in the context of fuel cell stacks and other multiple electrode arrangements, they are also applicable to single fuel cell arrangements. The reactant supply apparatus and byproduct removal apparatus described above also have application in fuel cells that merely include porous fuel distribution elements that do not create capillary forces. It is intended that the scope of the present inventions extend to all such modifications and/or additions.

We claim:

1. A fuel cell system, comprising:
an electrode defining a surface;
a capillary reactant distribution structure associated with the electrode and configured to distribute reactant over at least a substantial portion of the electrode surface; and
a reactant supply apparatus that supplies reactant to the capillary reactant distribution structure under pressure.

2. A fuel cell system as claimed in claim 1, wherein the electrode comprises an anode and the reactant comprises liquid fuel.

3. A fuel cell system as claimed in claim 1, wherein the capillary reactant distribution structure and the electrode are separate structural elements.

4. A fuel cell system as claimed in claim 1, wherein the reactant supply apparatus includes a pump.

5. A fuel cell system as claimed in claim 1, wherein the capillary reactant distribution structure defines a perimeter and the reactant supply apparatus includes at least one hollow member that transfers reactant to at least one region within the perimeter of the capillary reactant distribution structure.

6. A fuel cell system as claimed in claim 1, further comprising:
a byproduct removal apparatus that receives byproduct from the capillary reactant distribution structure.

7. A fuel cell system as claimed in claim 6, wherein the byproduct removal apparatus includes at least one substantially gas permeable, substantially liquid impermeable hollow member.

8. A fuel cell system as claimed in claim 1, wherein the electrode comprises a pair of electrodes defining respective surfaces and the capillary reactant distribution structure is located between the electrodes and configured to distribute reactant over at least a substantial portion of the respective electrode surfaces.

9. A method of supplying a liquid reactant to a fuel cell electrode having a surface, comprising the steps of:
supplying the liquid reactant to a capillary reactant distribution structure with an active element; and
distributing the liquid reactant over the electrode surface with the capillary reactant distribution structure.

10. A method as claimed in claim 9, wherein the step of supplying the liquid reactant to a capillary reactant distribution structure with an active element comprises supplying a liquid fuel to a capillary reactant distribution structure with an active element.

11. A method as claimed in claim 9, wherein the step of supplying the liquid reactant to a capillary reactant distribution structure with an active element comprises pumping liquid reactant to a capillary reactant distribution structure.

12. A method as claimed in claim 9, wherein the capillary reactant distribution structure defines an edge and the step of supplying the liquid reactant to the capillary reactant distribution structure with an active element comprises supplying the liquid reactant to the edge of the capillary reactant distribution structure with an active element.

13. A method as claimed in claim 9, wherein the capillary reactant distribution structure defines a perimeter and the step of supplying the liquid reactant to the capillary reactant distribution structure with an active element comprises supplying the liquid reactant to at least one region within the perimeter of the capillary reactant distribution structure with an active element.

14. A method as claimed in claim 9, further comprising the step of:
removing gaseous byproduct with at least one substantially gas permeable, substantially liquid impermeable hollow member.

15. A reactant supply system for supplying reactant to a fuel cell electrode having a surface, the reactant supply system comprising:
a capillary reactant distribution structure configured to distribute reactant over at least a substantial portion of the electrode surface; and
a reactant supply apparatus that supplies reactant to the capillary reactant distribution structure under pressure.

16. A reactant supply system as claimed in claim 15, wherein the reactant supply apparatus includes a pump.

17. A reactant supply system as claimed in claim 15, wherein the capillary reactant distribution structure defines a perimeter and the reactant supply apparatus includes at least one hollow member that transfers reactant to at least one region within the perimeter of the capillary reactant distribution structure.

18. A reactant supply system as claimed in claim 15, wherein the capillary reactant distribution structure defines a perimeter and the reactant supply apparatus includes a plurality of hollow members that transfer reactant to a plurality of regions within the perimeter of the capillary reactant distribution structure.

19. A reactant supply system for supplying reactant to a fuel cell electrode having a surface, the reactant supply system comprising:
a first reactant distribution structure configured to distribute reactant over at least a substantial portion of the electrode surface;
a reactant supply channel including a portion with a plurality of apertures; and
a second reactant distribution structure, in communication with the first reactant distribution structure, substantially surrounding the portion of the reactant supply channel with the plurality of apertures.

20. A reactant supply system as claimed in claim 19, wherein the first and second reactant distribution structures together define an integral reactant distribution structure.

21. A reactant supply system as claimed in claim 19, further comprising;
a cap that covers a substantial portion of the second reactant distribution structure and defines an opening through which reactant is transferred from the second reactant distribution structure to the first reactant distribution structure.

22. A reactant supply system as claimed in claim 19, wherein at least one of the first and second reactant distribution structures comprises a porous reactant distribution structure.

23. A reactant supply system as claimed in claim 22, wherein at least one of the first and second reactant distribution structures comprises a capillary reactant distribution structure.

24. A fuel cell, comprising:
an anode; and
a cathode;
at least one of the anode and the cathode including a reaction layer and a current collector configured to apply capillary forces to a reactant that distribute the reactant over the reaction layer and to conduct current.

25. A fuel cell as claimed in claim 24, wherein the anode includes the reaction layer and the current collector.

26. A fuel cell as claimed in claim 24, wherein the reaction layer comprises a catalyst layer.

27. A fuel cell as claimed in claim 24, wherein the current collector includes non-conductive porous hollow members.

28. A fuel cell as claimed in claim 24, wherein the current collector includes a non-conductive portion and a conductive portion.

29. A fuel cell as claimed in claim 24, wherein the current collector includes a plurality of conductive fibers.

30. A fuel cell electrode, comprising:
a reaction layer; and
a current collector configured to apply capillary forces to a reactant that distribute the reactant over the reaction layer and to conduct current.

31. A fuel cell electrode as claimed in claim 30, wherein the reaction layer comprises a catalyst layer.

32. A fuel cell electrode as claimed in claim 30, wherein the current collector includes non-conductive porous hollow members.

33. A fuel cell electrode as claimed in claim 30, wherein the current collector includes a non-conductive portion and a conductive portion.

34. A fuel cell electrode as claimed in claim 30, wherein the current collector includes a plurality of conductive fibers.

35. A fuel cell system, comprising:
an electrode defining a surface;
a capillary reactant distribution structure associated with the electrode, defining a perimeter and configured to distribute reactant over at least a substantial portion of the electrode surface; and
a reactant supply apparatus including at least one hollow member that transfers reactant to at least one region within the perimeter of the capillary reactant distribution structure.

36. A fuel cell system as claimed in claim 35, wherein the electrode comprises an anode.

37. A fuel cell system as claimed in claim 35, wherein the reactant supply apparatus include an active element.

38. A fuel cell system as claimed in claim 35, wherein the reactant supply apparatus includes a plurality of hollow members that transfer reactant to a plurality of regions within the perimeter of the capillary reactant distribution structure.

39. A fuel cell system as claimed in claim 38, further comprising:
at least one substantially gas permeable, substantially liquid impermeable byproduct removal hollow member located between two of the reactant supply hollow members.

40. A fuel cell system as claimed in claim 35, wherein the at least one hollow member is embedded within the capillary reactant distribution structure.

41. A fuel cell system as claimed in claim 35, wherein the electrode comprises a pair of electrodes defining respective surfaces and the capillary reactant distribution structure is located between the electrodes and configured to distribute reactant over at least a substantial portion of the respective electrode surfaces.

42. A fuel cell system, comprising:
an electrode;
a porous reactant distribution structure associated with the electrode and configured to distribute reactant over at least a substantial portion of the electrode surface; and
a substantially gas permeable, substantially liquid impermeable byproduct removal apparatus associated with the porous reactant distribution structure.

43. A fuel cell system as claimed in claim 42, wherein the electrode comprises an anode.

44. A fuel cell system as claimed in claim 42, wherein the porous reactant distribution structure comprises a capillary reactant distribution structure.

45. A fuel cell system as claimed in claim 42, wherein the porous reactant distribution structure defines a perimeter and the substantially gas permeable, substantially liquid impermeable byproduct removal apparatus comprises at least one substantially gas permeable, substantially liquid impermeable hollow member located within the perimeter of the porous reactant distribution structure.

46. A fuel cell system as claimed in claim 45, wherein the substantially gas permeable, substantially liquid impermeable hollow member is embedded in the porous reactant distribution structure.

47. A fuel cell system as claimed in claim 45, wherein the substantially gas permeable, substantially liquid impermeable hollow member comprises a hollow member with a plurality of apertures formed from a substantially gas and liquid impermeable material and a substantially gas permeable, substantially liquid impermeable lining.

48. A fuel cell system as claimed in claim 42, wherein the porous reactant distribution structure defines a perimeter and the substantially gas permeable, substantially liquid impermeable byproduct removal apparatus comprises a plurality of substantially gas permeable, substantially liquid impermeable hollow members located within the perimeter of the porous reactant distribution structure.

49. A fuel cell system as claimed in claim 47, further comprising:
a reactant supply apparatus including at least one reactant supply hollow member located between two of the substantially gas permeable, substantially liquid impermeable hollow members.

50. A fuel cell system as claimed in claim 42, further comprising:
an active element adapted to create a vacuum that draws gaseous byproduct into the substantially gas permeable, substantially liquid impermeable byproduct removal apparatus.

51. A method of operating a fuel cell including at least one electrode, comprising the steps of:
supplying liquid reactant to a region adjacent to the electrode; and
removing gaseous byproduct from the region adjacent to the electrode with a substantially gas permeable, liquid impermeable structure.

52. A method as claimed in claim 51, wherein the step of supplying liquid reactant to a region adjacent to the electrode comprises supplying liquid reactant to a porous structure adjacent to the electrode.

53. A method as claimed in claim 52, wherein the porous structure defines a perimeter and the step of removing gaseous byproduct from the region adjacent to the electrode with a substantially gas permeable, liquid impermeable structure comprises removing gaseous byproduct from the region within the perimeter with a substantially gas permeable, liquid impermeable structure.

54. A method as claimed in claim 52, wherein the porous structure defines a perimeter and the step of removing gaseous byproduct from the region adjacent to the electrode with a substantially gas permeable, liquid impermeable structure comprises removing gaseous byproduct from a plurality of regions within the perimeter with a plurality of substantially gas permeable, liquid impermeable structures.

55. A method as claimed in claim 51, further comprising the step:
applying a vacuum force to draw gaseous byproduct into the substantially gas permeable, liquid impermeable structure.

56. A fuel cell system, comprising:
at least one electrode defining a reaction surface; and
a reactant supply and byproduct removal structure, including a plurality of hydrophilic porous hollow fibers and a plurality of hydrophobic porous hollow fibers, positioned adjacent to the reaction surface.

57. A fuel cell system as claimed in claim 56, wherein the at least one electrode comprises a pair of electrodes defining respective reaction surfaces positioned in such that the reaction surfaces face one another and at least a portion of the reactant supply and byproduct removal structure is located between the reaction surfaces.

58. A fuel cell system as claimed in claim 56, wherein the at least one electrode comprises an anode.

59. A fuel cell for use with a predetermined reactant, comprising:
an electrode defining a surface; and
a reactant distribution structures including a plurality of channels that face the electrode surface, the channels being dimensioned such that they apply capillary forces to the reactant.

60. A fuel cell as claimed in claim 59, wherein the reactant distribution structure comprises an embossed film.
